(19) United States
(12) Patent Application Publication
(10) Pub. No.: US 2006/0095835 A1
(43) Pub. Date: May 4, 2006

(54) System and method for the modular generation of markup language

(76) Inventors: William Kennedy, Scottsdale, AZ (US); Pete Mueller, Fountain Hills, AZ (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 10/979,602

(22) Filed: Nov. 1, 2004

(51) Int. Cl. G06F 17/21; G06F 17/24; G06F 3/00; G06F 17/30

(52) U.S. Cl. 715/513; 707/1; 715/764; 715/530

(57) ABSTRACT

An exemplary system and method for the substantially modular design and construction of web pages and other markup language document content is disclosed as comprising inter alia: a database (5); a document code module (e.g., 135) that is at least partially derived from data in the database (5); and a substantially graphical user interface (200) for inserting (264), removing (242), hiding (244), showing (294), moving (262), modifying (246) or administrating at least one module (e.g., 235) in order to produce at least a portion of a markup language document (100). Disclosed features and specifications may be variously controlled, adapted or otherwise optionally modified to improve modular design and/or production of markup language content for any application or operating environment. Exemplary embodiments of the present invention generally provide for the production, publication and administration of web pages that may be readily integrated with an e-commerce storefront.

### FIELD OF INVENTION

The present invention generally concerns systems and methods for the substantially modular design and production of markup language documents and graphics; and more particularly, in various representative and exemplary embodiments, to electronic commerce (e-commerce) systems employing, for example, modularly generated Hypertext Markup Language (HTML) web content.

### BACKGROUND

Historically, the word ‘markup’ has been used to describe annotation or other marks within a document intended to instruct typesetters as to how a particular passage should be printed or laid out. Examples may include wavy underlining to indicate boldface, special symbols for passages to be omitted or printed in a particular font, and so forth. As the formatting and printing of documents has become automated with the use of computers, the term ‘markup’ has been extended to include various types of specialized codes inserted into electronic texts to govern formatting, printing and other print processing.

Expanding from this definition, ‘markup’ may be understood as a means of making an interpretation for the rendering of a particular document component, such as punctuation marks, capitalization, disposition of letters on a page, the spaces between words, and the like. These may be regarded as a type of markup, the function of which may be to aid the reader with the determination of, for example, where one word ends and another begins, or how to identify structural features such as headings or syntactic units such as dependent clauses or sentences. Accordingly, the formatting of a document for electronic processing may be likened to transcribing a manuscript in scriptio continua—essentially, the process of making explicit what may otherwise be conjectural by directing the reader or print producer as to how the document content should be viewed.

‘Markup language’ is typically understood to mean a set of markup conventions used together for formatting texts. Accordingly, a markup language usually specifies what markup is allowed, what markup is required, how the markup is to be distinguished from text, and what the markup codes mean. A descriptive markup system generally uses markup codes which provide names to categorize parts of a document. Markup codes such as <para> or \end{list} may identify a portion of a document and indicate of it that ‘the identified item is a paragraph’ or ‘the identify item is the end of the most recently begun list’, etc. By contrast, a procedural markup system typically defines what processing is to be carried out at particular points in a document, such as for example: ‘call procedure PARA with parameters 1, b and x’ or ‘set the left margin 2 quads left; move the right margin 2 quads right; skip down one line; and return to the left margin’, etc.

In Standard Generalized Markup Language (SGML), for example, the instructions needed to process a document for a particular purpose (e.g., to format the document) are generally distinguished from the descriptive markup which appears within the document. Often, these instructions may be collected outside the document in separate procedures or programs.

With descriptive instead of procedural markup, a document may be readily processed by many different software algorithms, each of which may apply different processing to those parts of the document which are considered relevant. For example, a content analysis program may disregard the footnotes embedded in an annotated text, while a formatting program may extract and collect them together for printing at the end of each chapter. Therefore, different processing instructions may be associated with the same parts of a file. Representatively, one program may extract names of persons and places from a document to create an index or database, while another, operating on the same text, might print names of persons and places in a distinctive typeface.

SGML also provides the feature of a document type, and hence a document type definition (DTD). Documents are generally regarded as having types, just as many other objects processed by computers do. The type of a document is typically determined by its constituent parts and their structure. The definition of a report, for example, might be that it consists of a title and possibly an author, followed by an abstract and a sequence of one or more paragraphs. Anything lacking a title, according to such a definition, would not formally be regarded as a report, and neither would a sequence of paragraphs followed by an abstract, despite any other ‘report-like’ characteristics the document might have for a particular reader.

If documents are of known types, a special purpose program (such as a parser) may be used to process a document of a particular type and check that all the components required for that document type are indeed present and correctly ordered. More specifically, different documents of the same type may be processed in a substantially uniform fashion. Programs may be written which take advantage of information embedded in the document structure data, thus allowing the application to behave intelligently.

Hypertext systems, such as HTML, generally improve on other markup language methods of handling text by supporting associative links within and across documents. By tagging links explicitly, rather than using proprietary methods, developers of HTML documents can be assured that the resources they create will be accessible on diverse computing platforms.

HTML is a language that is based on the SGML specification and has been adopted for defining the layout and attributes of World Wide Web documents, as well as for creating links between and within such documents. Notably, however, HTML is generally difficult for an average computer user to understand and work with. For example, in the commercial marketplace, there may be individuals well-versed in the marketing of products and services through conventional print media, but as companies move their marketing efforts to the World Wide Web, merchandising teams may not have the skills to effectively market products and services online. Part of the problem may be attributed to the complexity of the HTML standard, while another part may be due to the lack of easy-to-use tools for the design and production of web content. Accordingly, what may be representatively desired is a system and method to allow users having little or substantially no HTML training to produce, publish, modify and administrate HTML web content.

Additionally, companies may also wish to conditionally allow or otherwise restrict access to parts of their product catalog or merchandising tools depending on the identity of the user accessing the system. Accordingly, what may also be representatively desired is a system and method for allowing users conditional access to produce, publish, modify and/or administrate web content for secure e-commerce applications.

### SUMMARY OF THE INVENTION

In various representative aspects, the present invention provides a system and method for the modular design and production of web pages or other markup language content. Exemplary features are generally disclosed as including: a database; a markup language document having at least one document code module, wherein the markup language of the document code module is at least partially derived from data stored in the database; and an interface for managing at least one document code module in order to produce at least a portion of, for example, an HTML web page.

Additional advantages of the present invention will be set forth in the Detailed Description which follows and may be obvious from the Detailed Description or may be learned by practice of exemplary embodiments of the invention. Still other advantages of the invention may be realized by means of any of the instrumentalities, methods or combinations particularly pointed out in the claims.

### BRIEF DESCRIPTION OF THE DRAWINGS

Representative components, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other components, operational features, applications and/or advantages will become apparent to skilled artisans in light of certain exemplary embodiments recited in the Detailed Description, wherein:

FIG. 1 representatively illustrates a block diagram in accordance with an exemplary embodiment of the present invention;

FIG. 2 representatively illustrates a web page generated in accordance with an exemplary e-commerce embodiment of the present invention;

FIG. 3 representatively illustrates a module management interface in accordance with an exemplary e-commerce embodiment of the present invention;

FIG. 4 representatively depicts a module editing dialog in accordance with an exemplary e-commerce embodiment of the present invention;

FIG. 5 representatively depicts a first module insertion dialog in accordance with an exemplary e-commerce embodiment of the present invention;

FIG. 6 representatively depicts a second module insertion dialog in accordance with an exemplary e-commerce embodiment of the present invention; and

FIG. 7 representatively illustrates a product data editing dialog in accordance with an exemplary e-commerce embodiment of the present invention.

Those skilled in the art will appreciate that components in the Figures are illustrated for simplicity and clarity and have not necessarily been drawn to scale. For example, the dimensions of some of the components in the Figures may be exaggerated relative to other components to help improve understanding of various embodiments of the present invention.

Furthermore, the terms ‘first’, ‘second’, and the like herein, if any, are generally used for distinguishing between similar components and not necessarily for describing a sequential or chronological order. Moreover, the terms ‘front’, ‘back’, ‘top’, ‘bottom’, ‘over’, ‘under’, and the like, if any, are generally employed for descriptive purposes and not necessarily for comprehensively describing exclusive relative position or order. Skilled artisans will therefore understand that any of the preceding terms so used may be interchanged under appropriate circumstances such that various embodiments of the invention described herein, for example, are capable of operation in other orientations and environments than those explicitly illustrated or otherwise described.

### DETAILED DESCRIPTION OF EXEMPLARY EMBODIMENTS

The following descriptions are of exemplary embodiments of the invention and the inventors' conception of the best mode and are not intended to limit the scope, applicability or configuration of the invention in any way. Rather, the following Description is intended to provide convenient illustrations for implementing various embodiments of the invention. As will become apparent, changes may be made in the function and/or arrangement of any of the components described in the disclosed exemplary embodiments without departing from the spirit and scope of the invention.

A detailed description of an exemplary application, namely a system and method for the modular design and construction of an e-commerce storefront, is provided as a specific enabling disclosure that may be readily generalized by skilled artisans to any application of the disclosed system and method for the modular generation of any markup language document content.

As used herein, the terms “production” and “generation”, in addition to any functional or contextual variants thereof (particularly as they may relate to the authoring and/or development of markup language document content), may be understood to mean any aggregated or discrete steps at least partially involving the design, construction, layout, publication, organization, functional implementation, rendering, inclusion of features, and/or the aesthetic definition of at least a portion of markup language content.

The term “markup language document” may be understood to mean any electronic representation of information that may be at least partially rendered by a suitably adapted application for markup language interpretation, as well as any electronic and/or printed material(s) at least partially derived therefrom.

In the case where a “document code module” is generated or otherwise produced using the HTML specification, such a code module may be termed a “web code module”, insofar as the primary intended mode of publication may be by operation of a web server. However, wherever the term “document code module” appears, no such limitation on the mode of publication and/or communication should be presumed.

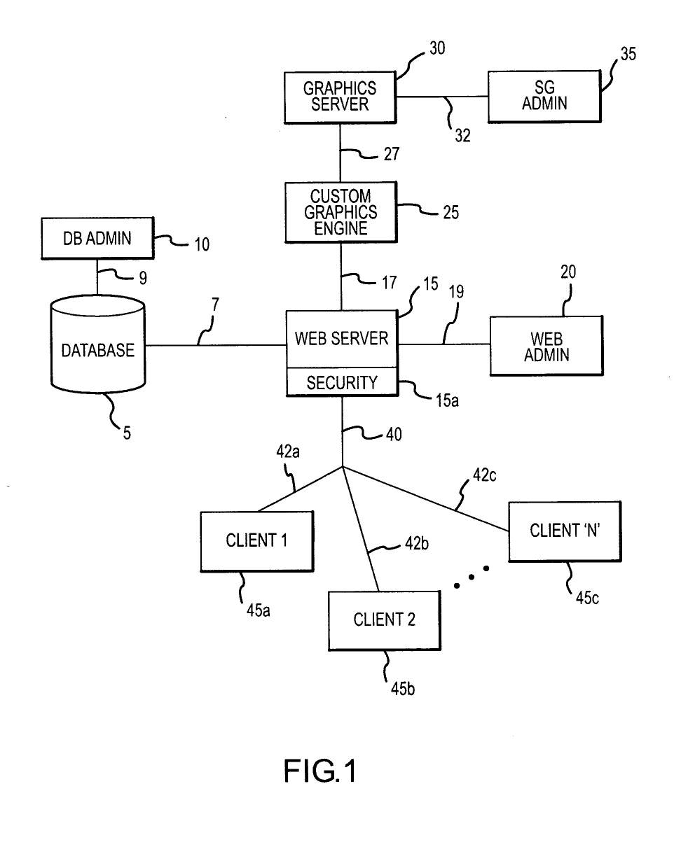

The exemplary merchandising system representatively illustrated in FIG. 1 may be configured to allow an average user to design, construct or otherwise produce the content of an e-commerce web site without having to acquire specific knowledge of HTML. The disclosed merchandising system employs a plurality of markup language document code modules (in this case, ‘web code modules’) that may be inserted, removed, hidden, shown, moved, modify or administrated, for example, on a web-based management interface by a user. Each module may be optionally adapted to comprise data components that may be employed to identify information specific to a particular code module.

Exemplary pre-configured modules may be provided by a developer in such a way that with the selection of particular data components such as, for example, product ID and price, a block of HTML code may be generated for publishing a particular product or service offering on a storefront web site. The merchandising system may also be configured to provide a module management interface for moving, editing, showing, hiding, removing, administrating, etc. a web code module at or otherwise effectively near the module's insertion point.

In the case of multiple storefronts, the merchandising system may be adapted to utilize an inheritance model and/or object property model for objects, such as code modules, classes, variables, and/or the like, such that properties or values may be inherited by or otherwise propagated to other objects. Accordingly, changes made to parent objects may be reflected in daughter objects. Additionally, users may be permitted to modify daughter objects substantially independently or each other in order to add or modify markup content as needed.

Skilled artisans will appreciate that any method of defining or propagating properties, values, functions, etc., whether now known or hereafter derived or otherwise subsequently described in the art, may be employed to provide a suitable inheritance-type and/or object property model in accordance with various representative embodiments of the present invention to achieve a substantially similar result.

While an exemplary aspect of the present invention is disclosed as generally embodying an e-commerce HTML-based merchandising system, the present invention may be easily extended to any area of web site or markup language document design or production where it may be necessary to allow average users to customize at least a portion of a markup language document without having to write markup language code. In an exemplary embodiment of the present invention, as generally illustrated in FIG. 1 for example, clients (45a, 45b, 45c) may represent individual people, entities or businesses equipped with computing devices to access or otherwise facilitate online communications. Clients (45a, 45b, 45c) may comprise any type of computing device, such as, for example, mainframe computers, desktop computers, workstations, terminal stations, laptop computers, handheld computers, personal information managers, smart devices, mobile phones and/or the like. Client computers (45a, 45b, 45c) may be located in a home or business environment with access to a network 40. In a representative application, access may be through the Internet 40 using, for example, a commercially-available web-browser application. Although a plurality of client computers (45a, 45b, 45c) is representatively depicted in FIG. 1, the disclosed exemplary system may be alternatively configured to operate with a substantially unitary client, such as in the case of a kiosk-type of merchandising station or a self-serve point-of-sale (POS) terminal.

Client data connections (42a,42b,42c) to network 40, as well as network data connection 40 itself, may comprise any combination of hardware, software and/or other networking components configured to provide data communication. A variety of conventional communications media and protocols may be used for data paths (42a,42b,42c) such as, for example, an Internet Service Provider (ISP) over the local loop, as is typically used in connection with standard modem communication, a cable modem, a Dish network, an ISDN connection, a Digital Subscriber Line (DSL), various wireless communication methods (e.g., 802.11b/g, BlueTooth, etc.) and/or the like. Client computers (45a, 45b, 45c) may also reside within a local area network (LAN) which interfaces to network 40 via a leased line (T1, T3, etc.). Such communication methods are well known in the art, and are covered in a variety of standard texts. See, for example: Gilbert Held, ‘Understanding Data Communications’ (1996).

In an exemplary embodiment, the present invention may be deployed in the context of a client base where ‘N’ (see 45c) may be quite large. In that case, network 40 may generally correspond to the Internet. As used herein, the term ‘Internet’ generally refers to a substantially global, packet-switched network utilizing the TCP/IP suite of protocols or any other suitable protocols. Notwithstanding the preceding, the present invention may be implemented in various other network contexts as well, including any future alternatives to the Internet, in addition to other suitable inter-networks or intra-networks based on either open or proprietary protocols. For further information concerning data network communication protocols, standards and applications utilized in connection with the Internet, see, for example: Dilip Naik, ‘Internet Standards and Protocols’ (1998); ‘Java 2 Complete’, various authors, (Sybex 1999); Deborah Ray And Eric Ray, ‘Mastering Html 4.0’ (1997); and Loshin, ‘TCP/IP Clearly Explained’ (1997).

Database 5 may be configured to store, for example, configuration data, property data, content data, design layout data, formatting data, template data, graphic script data, graphic images, text, navigation data, links, variables, parameters, fields, tables, programming code, script code, code libraries, markup tags, application objects, kinematic data, security data, multimedia data, product data, object selection data, browser data, cookie data, username data, password data, encryption data, and/or any other type of data, whether now known or hereafter described in the art, that may be useful for the generation of at least a portion of a markup language document. In an exemplary embodiment in accordance with the present invention, database 5 may comprise a third party tool, the schema of which may be proprietary to a particular merchant application.

Database 5 may be any type of database, such as relational, hierarchical, object-oriented, and/or the like. Representative database products that may be used to implement database 5 include DB2 by IBM (White Plains, N.Y.), any of the database products available from ORACLE CORPORATION (Redwood Shores, Calif.), MICROSOFT ACCESS by MICROSOFT CORPORATION (Redmond, Wash.), or any other database product. The database may be organized in any manner, including, for example, data tables, look-up tables, matchable data structures or any other method and/or data structure now known or hereafter derived or otherwise described by those skilled in the art.

Association of certain data may be accomplished through any data association technique known and practiced in the art. For example, the association may be accomplished either manually or automatically. Automatic association techniques may include, for example, a database search, a database merge, GREP, AGREP, SQL, and/or the like. Data association may be accomplished by a database merge function, for example, using a key field to generally partition the database according to a class of objects defined by the key field. For example, a certain class may be designated as a key field in both a first data table and a second data table, and the two data tables may then be merged on the basis of the class data in a key field. In an exemplary embodiment, the data corresponding to a key field in each of the merged data tables may be the same; however, data tables having similar, though not identical, data in key fields may also be merged by using AGREP, for example.

Database 5 may be configured to accept access from database administration client 10 via data path 9 in order to perform, for example, routine and/or incidental database administration functions. Database administration client 10 may comprise a web-based interface, a proprietary application front end, or any user interface suitably adapted to permit administration of database 5. In one embodiment, data path 9 may comprise a substantially internal communication path between database 5 and administration client application 10 running on a computer storing database 5. Alternatively, database administration client 10 may connect to database 5 remotely through a network connection 9 and/or a web server. For example, in a representative and alternative embodiment employing at least one remote database administration client, client computers (45a, 45b, 45c) may be optionally configured to access web server 15 via respective data paths (42a,42b,42c) connecting through the Internet 40 for subsequent access to and administration of database 5.

Web server 15 generally comprises any combination of hardware, software, and/or networking components configured to receive and process HTTP requests from client computers (45a, 45b, 45c) and provides a suitable website or other Internet-based user interface which is accessible by clients (45a, 45b, 45c). In an exemplary embodiment, the Internet Information Server, MICROSOFT Transaction Server, and MICROSOFT SQL Server, may be used in conjunction with the MICROSOFT operating system, MICROSOFT NT web server software, a MICROSOFT SQL database system, and a MICROSOFT Commerce Server. Additionally, components such as Access Sequel Server, Oracle, MySQL, InterBase, and/or the like may be used to provide a compliant database-driven web content management system.

The term ‘webpage’ or ‘web content’, as used herein, is not meant to limit the type of documents and applications that might be used to interact with client users (45a, 45b, 45c). For example, a typical website may include, in addition to standard HTML documents, various forms, Java applets, Javascript, active server pages (ASP), common gateway interface (CGI) scripts, extensible markup language (XML), dynamic HTML, cascading style sheets (CSS), helper applications, plug-ins, etc. or any other web-based content, whether now known, hereafter derived or otherwise described in the art.

Various representative embodiments of the present invention may be adapted to work with any number of web servers in any permutation of connectivity, such as that of a failover or bandwidth acceleration configuration. Skilled artisans will appreciate that numerous optional variants known in the art may be employed for the provision of web access to clients (45a, 45b, 45c).

Security layer 15a generally controls the availability of functions in the system (see FIG. 1) to a particular user. This may include graphic script creation, product data editing, selection of code modules to use with a particular merchandising page, database administration, web server administration, graphic server administration, and/or the like. For example, functions and features of the merchandising system may be enabled or disabled based on the identity of the user or to give an administrator control over who may modify the web site. As generally depicted, security layer 15a may be substantially integrated with web server 15. In various other representative embodiments, security layer 15a may be alternatively, conjunctively or sequentially configured as a substantially stand-alone component and/or may be optionally integrated with various other client-side or server-side system components.

Web server 15 may be configured to accept access from web server administration client 20 via data path 19 in order to perform, for example, routine and/or incidental web service administration functions. Web server administration client 20 may comprise a web-based interface, a proprietary application front end, or any user interface suitably adapted to permit administration of web server 15. In one embodiment, data path 19 may comprise a substantially internal communication path between web server 15 and web server administration client application 20 running on a substantially unitary computer. Alternatively, web server administration client 20 may connect to web server 15 remotely through a local network connection 19 and/or an Internet connection. For example, in a representative and alternative embodiment employing at least one remote web server administration client, client computers (45a, 45b, 45c) may be optionally configured to access web server 15 via respective data paths (42a,42b,42c) connecting through the Internet 40 for subsequent access to and administration of web server 15.

In an exemplary embodiment, in accordance with various representative aspects of the present invention, graphics server 30 comprises a system component suitably adapted to communicate with a third-party graphics application, such as, for example, ADOBE PHOTOSHOP by ADOBE SYSTEMS (San Jose, Calif.). One of the functions of graphic server 30 is to process a script of commands to manipulate graphic images using such a third-party graphics application. The custom graphic engine 25 and the content management system 31 may then be employed to use the resulting graphic image.

Graphics server administration client 35 is a system component that generally provides an interface for the creation of scripts subsequently used by the graphic server 30. Graphics server administration client 35 allows the creation of scripts used to render a particular graphic, as well as subscripts used by other scripts to render a particular part of a graphic image. In an exemplary embodiment in accordance with the present invention, such scripts and subscripts may be stored in database 5.

Graphics server 30 may be configured to accept access from graphics server administration client 35 via data path 32 in order to perform, for example, routine or incidental graphics server administration functions. Graphics server administration client 35 may comprise a web-based interface, a proprietary application front end, or any user interface suitably adapted to permit administration of graphics server 30. In one embodiment, data path 32 may comprise a substantially internal communication path between graphics server 30 and graphics server administration client application 35 running on a substantially unitary computer. Alternatively, graphics server administration client 35 may connect to graphics server 30 remotely through a local network connection 32 and/or an Internet connection. For example, in a representative and alternative embodiment employing at least one remote graphics server administration client, client computers (45a, 45b, 45c) may be optionally configured to access graphics server 30 via respective data paths (42a,42b,42c) connecting through the Internet 40 for subsequent access to and administration of graphics server 30.

Custom graphics engine 25 communicates with graphics server 30 by operation of data path 27. The custom graphics engine 25 selects the relevant graphic scripts and merchandising variables to produce a graphics script passed to the graphic server 30. Once a graphic image has been returned to file server 11, web server 15 receives the post-processed image from file server 11 over data path 12. Content management control layout passes HTML to web server 15 for subsequent display of the resulting image in the appropriate areas of the web site. The custom graphics engine 25 may also be suitably adapted to inform the web servers 15 and/or database 5 when a graphic image has been updated.

Data connections (7, 19, 27, 32) may comprise any combination of hardware, software and/or other networking components configured to provide communication data paths. A variety of conventional communications media and protocols may be used for data paths (7, 19, 17, 27, 32) such as, for example, an Internet Service Provider (ISP) over the local loop, as is typically used in connection with standard modem communication, a cable modem, a Dish network, an ISDN connection, a Digital Subscriber Line (DSL), various wireless communication methods (e.g., 802.11b/g, BlueTooth, etc.) and/or the like. Device components connected via data paths (7, 19, 17, 27, 32) may also reside within a local area network (LAN) which interfaces to an external network, such as the Internet, via a leased line (T1, T3, etc.). Notwithstanding the preceding, skilled artisans will appreciate that the present invention may be implemented in other network environments as well, including any future alternatives to the Internet, in addition to other suitable inter-networks and/or intra-networks based on other open or proprietary protocols.

The disclose system and method may also be configured to include additional components, such as a product picker, a content manager 31, a merchandising server 31, and a merchandising interface:

The product picker component may be configured to use a web-based interface to select various products from a catalog of products stored in database 5, and may be employed in several applications of the disclosed merchandising system to select a single product or a plurality of products.

The content management component generally allows fields of information in the product catalog to be edited. In addition to conventional editing of product data, this component may also be configured to include a ‘Delta system’ that allows the target product to be edited, as well as copies of the product data to be used for a particular store or user. Using the Delta system, a company with multiple stores or a plurality of user levels can make different product information available while optimizing the total volume of stored data.

The merchandising server component may be configured to control the editing and display of merchandising modules. In a representative e-commerce embodiment, a module may comprise a block of HTML code and a series of graphic scripts in conjunction with a group of variables that change the look, feel, or data of the web page to be rendered. Modules may be grouped together as a ‘layout’. In one exemplary aspect, each page of a particular e-commerce web site using the merchandising system may have an associated layout. The merchandising server component may also be adapted to allow the selection of an appropriate template for a page in a web site, as well as performing behind-the-scenes updates to database 5.

The merchandising interface generally provides a front end to the functions performed by the merchandising server. In an exemplary embodiment, the merchandising interface may be written in HTML and usable by clients with a web browser. The merchandising interface allow changes to the layout of web pages, changes to individual modules, and/or modification of a collection of pages comprising a particular web site.

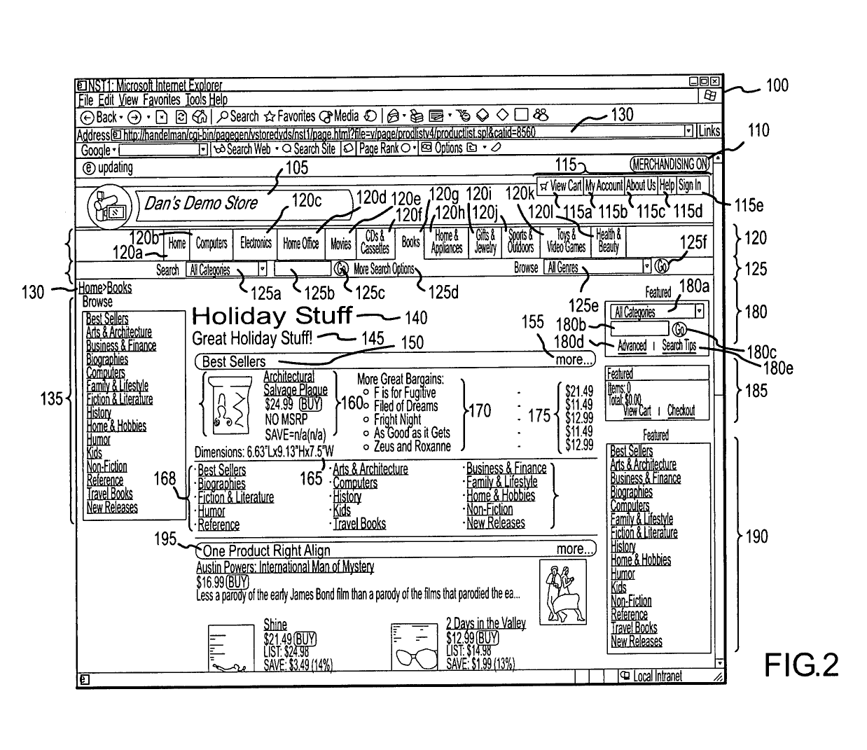

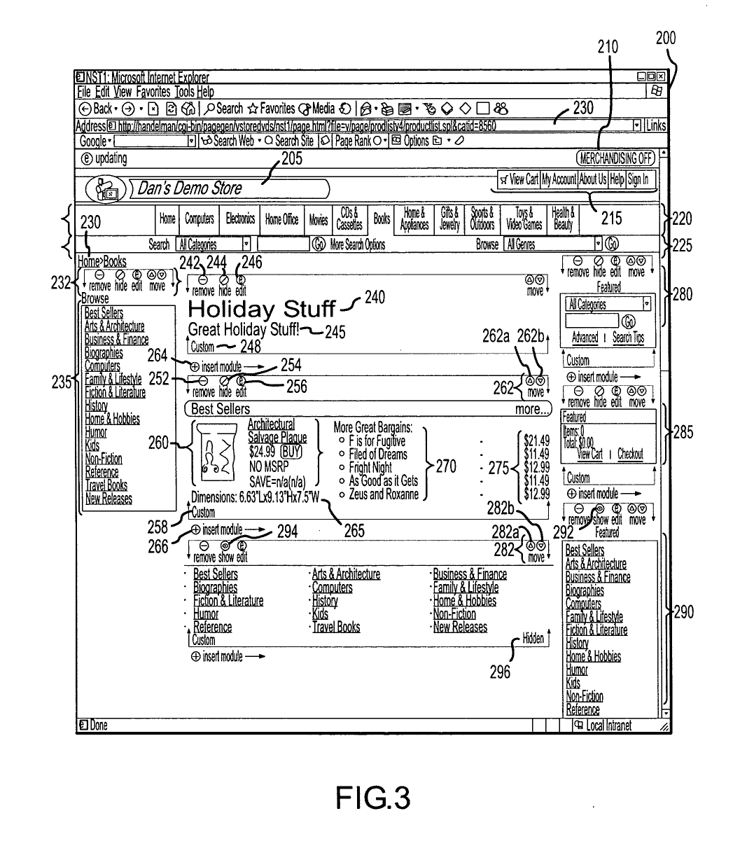

A web page 100, generated in accordance with an exemplary e-commerce embodiment of the present invention, is representatively illustrated in FIG. 2. Web page 100 has components that may include the following: a title 105; a status indicator 110 (‘Merchandising Off’; compare with 210 in FIG. 3); a navigation bar 115; a ‘View Cart’ navigation component 115a; a ‘My Account’ navigation component 115b; an ‘About Us’ navigation component 115c; a ‘Help’ navigation component 115d; a ‘Sign In’ navigation component 115e; a category bar 120; a ‘Home’ category component 120a; a ‘Computers’ category component 120b; an ‘Electronics’ category component 120c; a ‘Home Office’ category component 120d; a ‘Movies’ category component 120e; a ‘CDs & Cassettes’ category component 120f; a ‘Books’ category component 120g; a ‘Home & Appliances’ category component 120h; a ‘Gifts & Jewelry’ category component 120i; a ‘Sports & Outdoors’ category component 120j; a ‘Toys & Video Games’ category component 120k; a ‘Health & Beauty’ category component 120(l); a search/browse bar 125; a search category drop-down list 125a; a search keyword field 125b; a search execution control 125c; an advanced search options link 125d; a browse category drop-down list 125e; a browse execution control 125f; a navigation index 130; sub-category browsing links 135; a category display title 140; an optional category display tag-line 145; a first product/service sub-module 150; a first sub-module expanding link 155; product/service description 160; additional product/service information 165; quick category links 168; bargain links 170; price information 175; a featured products/services pane 180; a featured product/service search category drop-down list 180a; a featured product/service search keyword field 180b; a featured product/service search execution control 180c; a featured product/service advanced search options link 180d; a featured product/service searching tips link 180e; a featured items purchase index 185; a featured products/services category links 190; and a second product/service sub-module 195. Skilled artisans will appreciate that web page 100 may also include various other components known in the art of web content production that may not be explicitly illustrated herein.

Title 105 may provide general information identifying the area of the web site being accessed. Status indicator 110, when reading for example ‘Merchandising Off’, may indicate to the user that they are accessing web page 100 in a mode adapted for the purchasing of products and/or services. Navigation bar 115 may provide tools to provide the user with information concerning their purchases, their account, or the online store. Category bar 120 may facilitate the categorization of goods and services offered by the merchant for purchase on web page 100. Where goods and services may not be readily found using category bar 120, a search/browse tool 125 may be provided for entry of keyword(s) 125b to target a search within the site's offerings. Navigation index 130 generally displays the user's current category location in the product/service catalog. Category title 140, optional category tagline 145 and sub-category browsing links 135 may also be provided to aid the user in their search to find good or services of interest.

Product/service sub-module 150 may include a link 155 to provide additional information concerning the identified product and/or service in addition to a description 160 of the offering, various additional information 165 for the offering, quick category links 168, bargain links 170, and/or price information 175. Featured products and/or services may appear in a featured pane 180 that may further include, for example, a search category drop-down list 180a, a search keyword field 180b, a search execution button 180c, an advanced options link 180d, a searching tips link 180e, a purchase index 185 (e.g., to display the number of items, total cost, etc.), and category links 190.

In accordance with an exemplary aspect of the present invention, FIG. 3 representatively depicts a module management interface that may be adapted to produce, for example, the web page 100 generally illustrated in FIG. 2. Module management interface 200 may be accessed via Internet Explorer, Netscape, Opera, Safari and/or any other web browser application, whether now known or hereafter described in the art. Management interface 200 representatively includes, for example: a title 205; a status indicator 210 (‘Merchandising On’; compare with 110 in FIG. 2); a navigation bar 215; a category bar 220; a search/browse bar 225; navigation index 230; a web code module control and selection bar 232 for sub-category browsing links module; sub-category browsing links module content 235; category display module title content 240; a remove module control/selection component 242 for category title module; a hide module control/selection component 244 for category title module; an optional category display tag-line 245; an edit module control/selection component 246 for category title module; a module class identifier 248; a first product/service module 250; a remove module control/selection component 252; a hide module control/selection component 254; an edit module control/selection component 256; a module class identifier 258; a product and/or service descriptor 260; module location control components 262; a module location control component 262a for moving current module up; a module location control component 262b for moving current module down; additional product/service information 265; an insert module control/selection component 266 for introducing a new module; bargain links module content 270; price information module content 275; a featured products and/or services module 280; module location control components 282 for a second module; module location control component 282a for moving second module up; module location control component 282b for moving second module down; featured items purchased index module 285; featured products and/or services category links module 290; a show module control/selection component 292 for featured products/services category links module (currently hidden); a show module control/selection component 294 for second module (currently hidden; see 296); a module status identifier 296 (e.g., ‘Hidden’, ‘Locked’, ‘Displayed’, etc.); and/or the like.

Module control and selection bar 232, in this case for the sub-category browsing links 235 module, includes control/selection components for removing, hiding, editing and moving module 235. Various other modules having similar control/selection components appear throughout various portions of FIG. 3. For example, remove module control/selection component 242 may be used to delete title text 240 and title tagline 245 from the web page 100 being designed in module management interface 200, and subsequently, from final rendering on web page 100. However, hide module control/selection component 244 may be used to obscure the same content (240, 245) from final rendering of web page 100, while preserving the hidden module content in the design view of module management interface 200. If a module has been previously hidden by operation of a hide module selection, the same module may be later displayed in the rendering of the final web page by operation of a show module control/selection component (294, 292).

A module class identifier 248 (e.g., ‘standard’, ‘custom’, etc.) may also appear in the design view to indicate the source, status, function or other information concerning the particular module of interest. Where a module is obscured from final rendering for example, a status indication of ‘Hidden’ 296 may appear. Module location control components 262 may be used to alter the position of a module's appearance in the final rendered page. For example, control component 262a may be used to move the corresponding module up above the immediately preceding module, or control component 262b may be used to move the module down below the immediately following module. Alternatively, conjunctively or sequentially, module management interface 200 may be optionally adapted to allow the user to click on a module and drag it to a location of the user's choosing.

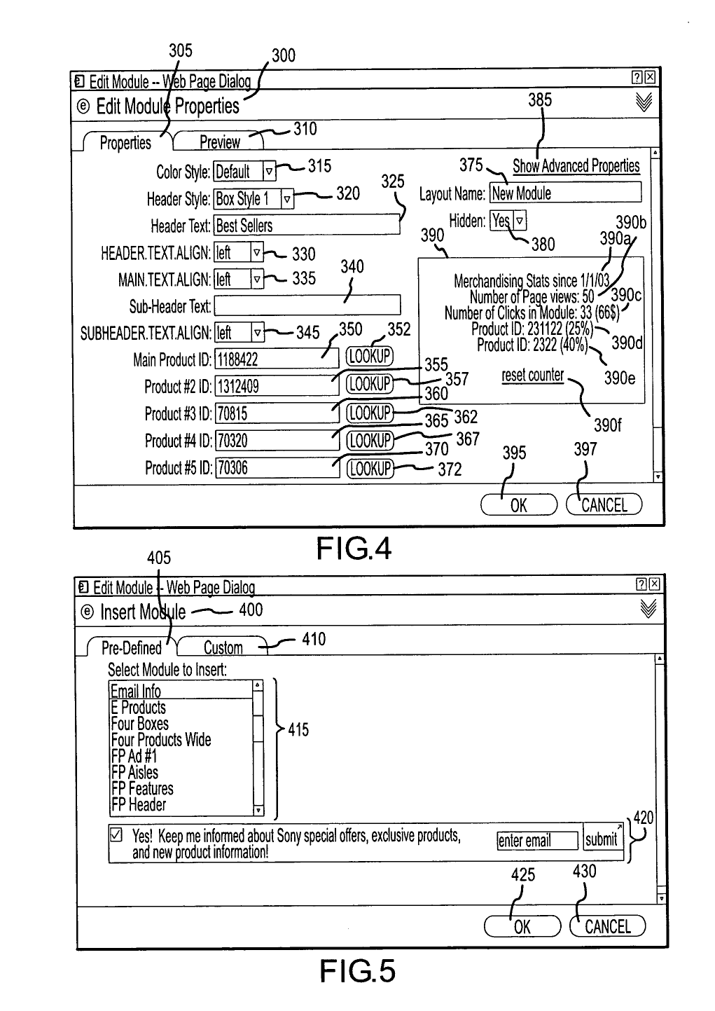

After accessing the edit module control component 256, an module editing window 300, as representatively illustrated for example in FIG. 4, may be presented to the user. In an exemplary embodiment in accordance with a representative aspect of the present invention, editing dialog 300 may comprise two tabbed panes: a property tab 305 and a preview tab 310. Preview tab 310 generally permits the user to view a pre-rendered version of proposed and/or selected changes to the module substantially prior to pushing any changes to the design view of module management interface 200. Dialog window 300 may also include: a color style property drop-down list 315 for selection of a color scheme; a header style property drop-down list 320 for selection of header text font formatting; a header text entry field 325 for entry of text to be display in the module's header; a header text alignment drop-down list 330 for selection of header text alignment formatting; a main text alignment drop-down list 335 for selection of main text alignment formatting; a sub-header text entry field 340 for entry of text to be displayed in the modules sub-header; a sub-header text alignment drop-down list 345 for selection of sub-header text alignment formatting; a main product identification text entry field 350 for entry of main product identification information; a main product identification lookup button 352 to access a tool to look-up unknown main product identification information; a product #2 identification text entry field 355 for entry of main product identification information; a product #2 identification lookup button 357 to access a tool to look-up unknown product #2 identification information; a product #3 identification text entry field 360 for entry of product #3 identification information; a product #3 identification lookup button 362 to access a tool to look-up unknown product #3 identification information; a product #4 identification text entry field 365 for entry of product #4 identification information; a product #4 identification lookup button 367 to access a tool to look-up unknown product #4 identification information; a product #5 identification text entry field 370 for entry of product #5 identification information; a product #5 identification lookup button 372 to access a tool to look-up unknown product #5 identification information; a module layout name text entry field 375 to define or access predefined module layouts; a hidden (yes/no) drop-down list 380 to select whether the generated module is to be hidden or shown; a module advanced properties link 385 to access and or edit the modules advanced properties. Furthermore, edit dialog 300 properties pane 305 may also include a merchandising statistics panel 390 comprising: a merchandising statistics title 390a that may or may not indicate the date of the most recent updates to the module's statistical information; the number of page views 390b that have occurred; the number of clicks 390c in module that have occurred; the product distribution 390d for a particular product (e.g., ID 231122); the product distribution 390e for another product (e.g., ID 2322); a merchandising statistics reset link 390f to restart the accumulation of statistical data. Additionally, the edit module dialog 300 may be further configured with an accept changes button 395 to implement the changes made in the edit module dialog window for inclusion in the design view of module management interface 200 and/or a cancel changes button 397 to abandon the proposed changes made in the module dialog 300 and to return to the design view of module management interface 200. Skilled artisans will appreciate that the preview area need not be limited to a panel or frame as representatively depicted in the Figures. Preview area may also comprise a pop-up window, a dialog box, a tabbed pane, and/or the like.

A module insertion control/selection component 266 may be provided to introduce a new module at a specified point within the web code document displayed in management interface 200. FIG. 5 illustrates a representative module insertion dialog window 400 in accordance with an exemplary embodiment of the present invention. For example, insertion dialog 400 may comprise two tabbed panes: a pre-defined module tab 405 and a custom module tab 410. Pre-defined tab 405 may be used for selecting substantially pre-defined web code module components for addition to a web page at the selected insertion point. Alternatively, conjunctively or sequentially, custom tab 410 may be used for selecting template web code module components that may be customized by the user.

Pre-defined tab 405 may be configured with a web code module drop-down list 415 for selection of a substantially pre-defined module. As a particular module is selected, a preview area 420 may be provided to permit the user to see an at least partially rendered version of the module prior to insertion in the web code document of interest. Skilled artisans will appreciate that such a preview area 420 need not be limited to a panel or frame as representatively depicted in FIG. 5. Preview area may also comprise a pop-up window, a dialog box, a tabbed pane, and/or the like.

Additionally, the insertion module dialog 400 may be further configured with an accept changes button 425 to implement the changes made in the insertion module dialog window for inclusion in the design view of module management interface 200 and/or a cancel changes button 430 to abandon the proposed changes made in the module dialog 400 and to return to the design view of module management interface 200.

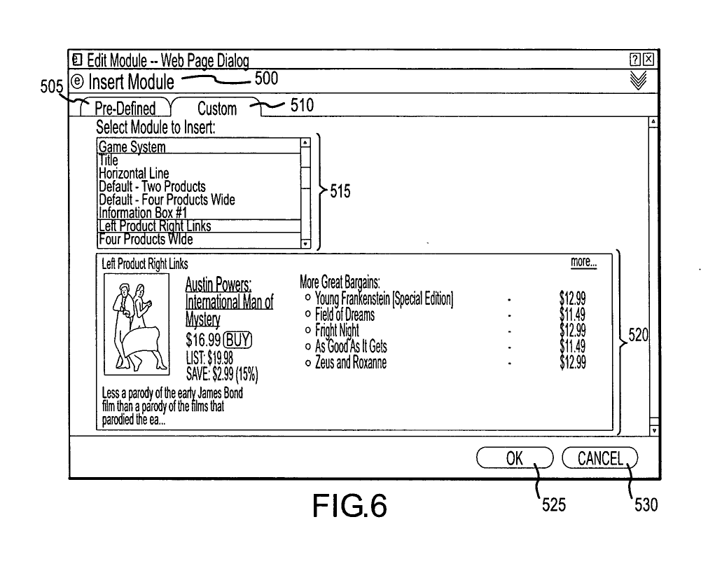

FIG. 6 illustrates a representative module insertion dialog window 500 in accordance with another exemplary embodiment of the present invention. For example, insertion dialog 500 may comprise two tabbed panes: a pre-defined module tab 505 and a custom module tab 510. Pre-defined tab 505 may be used for selecting substantially pre-defined web code module components for addition to a web page at the selected insertion point. Alternatively, conjunctively or sequentially, custom tab 510 may be used for selecting template web code module components that may be used for selecting substantially user-defined code module components for addition to a web page at the selected insertion point.

Custom tab 510 may be configured with a web code module drop-down list 515 for selection of a template or custom module. As a particular module is selected, a preview area 520 may be provided to permit the user to see an at least partially rendered version of the custom module prior to insertion in the web code document of interest. Skilled artisans will again appreciate that such a preview area 520 need not be limited to a panel or frame as representatively depicted in FIG. 6. Preview area may also comprise a pop-up window, a dialog box, a tabbed pane, and/or the like.

Additionally, the module insertion dialog 500 may be further configured with an accept changes button 525 to implement the changes made in the module insertion dialog window for inclusion in the design view of module management interface 200 and/or a cancel changes button 530 to abandon the proposed changes made in the module dialog 500 and to return to the design view of module management interface 200.

In addition to the above identified types of modules, skilled artisans will appreciate that various other types of modules may also be used. For example, modules may be configured in a nested relationship with one another or may themselves comprise a plurality of sub-module components. In the case where a module is intended to serve as a place-holder for example, the module may be invisible, hidden or otherwise obscured from final rendering. Alternatively, conjunctively, and/or sequentially, a module may contain data that may be useful or otherwise accessible to other modules. In this case, such a module may be configured as a dummy module.

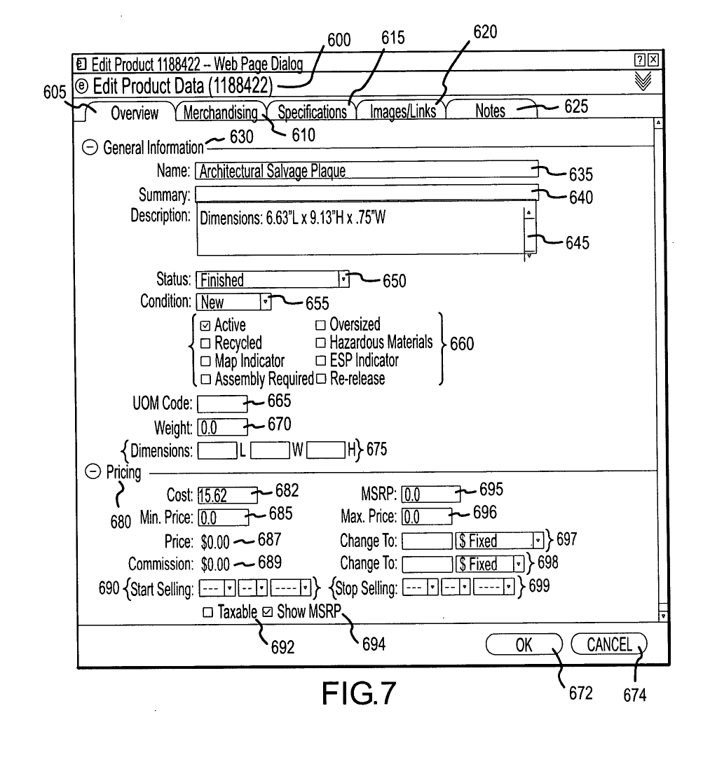

FIG. 7 representatively depicts a product data editing dialog 600 in accordance with an exemplary embodiment of the present invention. Product editing dialog 600 (here for Product No. 1188422) may be configured to comprise a plurality of tabs for various functions that may be applied to alter product data contained in database 5. Such grouping of functions may include inter alia: an overview data tab 605 for the entry of general product information; a merchandising data tab 610 for the entry of product merchandising information; a product specification data tab 615 for the entry of product specification data; an images/links data tab 620 for the entry of product images and/or links; a notes data tab 625 for the entry of product notes or miscellaneous information; and/or the like.

General Information tab 605, representatively identified by label 630, may further comprise: a product name text entry field 635 for identification of the product data being edited; a summary information text entry field 640 for the entry of product summary information; a product description text entry field 645 for the entry of more detailed product description information; a product status drop-down list 650 to select the current status of the particular product/service of interest; a product condition drop-down list 655 to indicate the condition of the product offering; a miscellaneous product information checkbox selections 660 for standard categorization of product information; a product UOM Code text entry field 665; a product weight text entry field 670 to indicate the weight of the product offering; a product dimensions text entry fields 675 to indicate the physical dimensions of the product offering; a product pricing section 680 to provide a grouping of data fields relating to the price of the product offering; a product cost text entry field 682 indicating the merchant's cost for the product offering; a product minimum price text entry field 685 indicating the lowest price that the merchant is willing to accept for sale of the product offering; product price data 687 indicating, for example, the current price of the product offering; product commission data 689 indicating, for example, the current sales commission being offered for the product of interest; a date to start selling product drop-down lists 690 indicating when the product is intended to be offered for sale; a product tax status checkbox 692 indicating if the sale of the product constitutes a taxable transaction; a checkbox to select whether to display the Manufacturer's Suggested Retail Price (MSRP) information 694, MSRP data text entry field 695 indicating the current MSRP value; a product maximum price text entry field 696 indicating the maximum price for sale of the product offering; a first ‘change to’ text entry field and drop-down list 697 indicating changes to the product commission; a second ‘change to’ text entry field and drop-down list 698 indicating changes to the product price; a date to stop selling product drop-down lists 699 indicating the date after which the product will no longer be offered for sale; and/or the like.

Additionally, the product editing dialog 600 may be further configured with an accept changes button 672 to implement the changes made to the product data for modification in database 5 and/or a cancel changes button 674 to abandon the proposed changes made in the product data and, in one exemplary and representative embodiment of the present invention, to return to the design view of module management interface 200.

Skilled artisans will appreciate that the data connection configurations depicted in the figures are provide for representative and convenient illustration and that many other data connection configurations may be alternatively, conjunctively and/or sequentially employed to produce substantially the same result. The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory components, processing components, logic components, data structures, and/or the like, which may carry out a variety of functions under the control of one or more microprocessors or other control devices. Similarly, the software components of the present invention may be implemented with any programming or scripting language such as, for example, C, C++, Java, COBOL, assembler, PERL, extensible Markup Language (XML), etc., and/or any programming or scripting language now known or hereafter derived or otherwise described in the art, with the various algorithms being implemented with any combination of data structures, objects, processes, routines or other programming components. Furthermore, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction to cryptography and digital security, please see the text by Bruce Schneider entitled “Applied Cryptography: Protocols, Algorithms, and Source Code In C,” published by John Wiley & Sons (second edition, 1996).

It should be appreciated that the particular implementations shown and described herein are representative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between various components. It should be noted that many alternative or additional functional relationships or physical connections may be present in a practical system.

It will be appreciated, that many applications of the present invention could be formulated. One skilled in the art will appreciate that the network may include any system for exchanging data, such as, for example, the Internet, an intranet, an extranet, WAN, LAN, wireless network, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., PALM PILOT, POCKET PC), cellular phone and/or the like. Similarly, the invention could be used in conjunction with any type of personal computer, network computer, workstation, minicomputer, mainframe, and/or the like running any operating system such as any version of Windows, Windows XP, Windows ME, Windows NT, Windows2000, Windows 98, Windows 95, MacOS, OS/2, BeOS, Linux, UNIX, or any operating system now known or hereafter derived by those skilled in the art. Additionally, the invention may be readily implemented with TCP/IP communications protocols, IPX, Appletalk, IP-6, NetBIOS or any number of existing or future standards or protocols. Moreover, the system contemplates the use, sale and/or distribution of any goods, services or information having similar functionality described herein.

The computing units may be connected with each other via a data communication network. The network may be a public network and assumed to be insecure and open to eavesdroppers. In one exemplary implementation, the network may be embodied as the Internet. In this context, the computers may or may not be connected to the Internet at all times.

A variety of conventional communications media and protocols may be used for data links, such as, for example, a connection to an Internet Service Provider (ISP) over the local loop, as is typically used in connection with standard modem communication, cable modem, Dish networks, ISDN, Digital Subscriber Line (DSL), or various wireless communication methods. Systems in accordance with the present invention might also reside within a local area network (LAN) which interfaces to a network via a leased line (T1, T3, etc.). Such communication methods are generally well known in the art, and are covered in a variety of standard texts.

As will be appreciated by skilled artisans, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code embodied in the storage medium. Any suitable computer-readable storage medium may be utilized, including hard disks, CD-ROM, optical storage devices, magnetic storage devices, and/or the like.

Data communication may be accomplished through any suitable communication means, such as, for example, a telephone network, Intranet, Internet, point of interaction device (POS device, personal digital assistant, cellular phone, kiosk, etc.), online communications, off-line communications, wireless communications, and/or the like. One skilled in the art will also appreciate that any databases, systems, or components of the present invention may consist of any combination of databases or components at a single location or at multiple locations, wherein each database or system optionally includes any of various suitable security features, such as firewalls, access codes, encryption, de-encryption, compression, decompression, and/or the like.

The present invention is described herein with reference to screen shots, block diagrams, devices (e.g., systems), and computer program products according to various aspects of the invention. It will be understood that each functional block of the block diagrams, and combinations of functional blocks in the block diagrams, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the block diagrams.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block diagrams. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the block diagrams.

Accordingly, the block diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams, can be implemented by either special purpose hardware-based computer systems which perform the specified functions or steps, or suitable combinations of special purpose hardware and computer instructions.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above. For example, the steps recited in any method or process claims may be executed in any order and are not limited to the specific order presented in the claims. Additionally, the components and/or components recited in any system claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problems or any component that may cause any particular benefit, advantage or solution to occur or to become more pronounced are not to be construed as critical, required or essential features or components of any or all the claims.

As used herein, the terms ‘comprises’, ‘comprising’, or any variation thereof, are intended to reference a non-exclusive inclusion, such that a process, method, article, composition or apparatus that comprises a list of components does not include only those components recited, but may also include other components not expressly listed or inherent to such process, method, article, composition or apparatus. Other combinations and/or modifications of the above-described structures, arrangements, applications, proportions, components, materials or components used in the practice of the present invention, in addition to those not specifically recited, may be varied or otherwise particularly adapted by those skilled in the art to specific environments, manufacturing specifications, design parameters or other operating requirements without departing from the general principles of the same.

We claim:

1. A system for producing at least a portion of a markup language document, said system comprising:
a database having data stored therein;
a document code module comprising markup language, said markup language of said document code module at least partially derived from data in said database;
a management interface comprising a substantially graphical user interface for at least one of inserting, removing, hiding, showing, moving, modifying and administrating at least one document code module in order to produce at least a portion of said markup language document; and
said management interface suitably adapted for communication with said database.

2. The system of claim 1, wherein said data comprises at least one of: configuration data, property data, content data, design layout data, formatting data, template data, graphic script data, a graphic image, text, navigation data, a link, a variable, a parameter, a field, a table, programming code, script code, a code library, a markup tag, an application object, security data, multimedia data, product data, object selection data, browser data, cookie data, username data, password data, and encryption data.

3. The system of claim 1, wherein said document code module further comprises at least one of a title, a label, a description, a shape, a line, a frame, a panel, a table, a dialog box, a drop-down menu, markup text, a list, a combo box, a text box, a radio selection button, an option button, a checkbox, a command button, a formatting tag, an option group, a toggle button, an unbound object frame, a bound object frame, a page break, a tab control, a sub-form, a sub-report, a style sheet, a static variable, a dynamic variable, a parametric variable, a spreadsheet, a web object, an OLE object, a plug-in, script code, sound, animation, and video.

4. The system of claim 1, further comprising:
at least one of a management client, a service client, a database administration client, a web server, a web server administration client, a custom graphics engine, a content management merchandising server, a graphics server, and a graphics server administration client; wherein:
said management client is suitably adapted to access said management interface;
said service client is suitably adapted to access said markup language document;
said web server is suitably adapted to communicate with said database and provide said markup language document to the service client;
said content management merchandising server is suitably adapted for allow a user to select an appropriate layout for said markup language document and for performing updates to the database;
said custom graphics engine is suitably adapted to access the graphics server and communicate with the web server; and
said graphics server administration client is suitably adapted to access and administrate the graphics server.

5. The system of claim 1, wherein said markup language document comprises an HTML document and said document code module comprises HTML code.

6. An e-commerce storefront in accordance with the system of claim 5, comprising:
a product selection component for selecting at least one product from a catalog of products stored in the database;
a content management component for allowing product catalog information to be modified;
a security layer component for restricting the availability of functions to authorized users of the system;
a merchandising server component for selecting an appropriate layout for said HTML document and for performing updates to the database; and
wherein said management interface comprises a merchandising interface for providing user access to the functions performed by the merchandising server.

7. The system of claim 6, further comprising:
at least one of a management client, a service client, a database administration client, a web server, a web server administration client, a custom graphics engine, a graphics server, and a graphics server administration client; wherein:
said management client is suitably adapted to access said management interface;
said service client is suitably adapted to access said HTML document;
said database administration client is suitably adapted to access and administrate the database;
said web server is suitably adapted to communicate with said database and display said HTML document to the service client;
said web server administration client is suitably adapted to access and administrate the web server;
said custom graphics engine is suitably adapted to access the graphics server and communicate with the web server; and
said graphics server administration client is suitably adapted to access and administrate the graphics server.

8. A method for producing at least a portion of a markup language document using the system of claim 1, said method comprising the step of using the merchandising server for at least one of inserting, removing, hiding, showing, moving, modifying and administrating at least one document code module to produce at least a portion of said markup language document.

9. A method for providing users with the ability to produce at least a portion of a markup language document, said method comprising the steps of:
providing a database suitably adapted to store data therein;
providing a document code module, said module comprising markup language, said markup language at least partially based on data in said database; and
providing a module management user interface, said management interface comprising a substantially web-based interface for at least one of inserting, removing, hiding, showing, moving, modifying and administrating at least one document code module to produce at least a portion of said markup language document.

10. The method of claim 9, further comprising the steps of:
changing said document code module by at least one of inserting, removing, hiding, showing, moving, modifying and administrating said module within said markup language document; and
updating at least one data component in said database to reflect the change.

11. The method of claim 9, wherein said step of providing a document code module further comprises the step of providing a module template to permit the user to define customized module features.

12. The method of claim 9, further comprising the step of displaying said markup language document to an end-user by at least one of:
accessing a published markup language document from a web server; and
rendering the markup language document substantially concurrent with a display request based on data stored in said database.

13. The method of claim 9, wherein:
said markup language document comprises at least one of an HTML document and an SGML document; and
said web-based management interface comprises a web browser.

14. The method of claim 9, wherein said markup language document comprises HTML content accessible from an e-commerce storefront and said data comprises product data.

15. The method of claim 9, where at least one of said module code and said data further comprises at least one of a object property model and an inheritance model.

16. The method of claim 9, wherein said document module comprises at least one of a standard module with substantially predefined properties, a custom module with substantially user-defined properties, a sub-module, an invisible module, a dummy module, and a nested module.

17. The method of claim 9, further comprising the step of restricting the availability of functions to authorized users.

18. The method of claim 9, further comprising the step of providing at least one of a custom graphic engine, a graphics server, a web server, an application merchandising server, a database administration application, a graphic script administration application, and a web server administration application.

19. The method of claim 9, wherein:
said data comprises at least one of configuration data, property data, content data, design layout data, formatting data, template data, graphic script data, a graphic image, text, navigation data, a link, a variable, a parameter, a field, a table, programming code, script code, a code library, a markup tag, an application object, kinematic data, security data, multimedia data, product data, object selection data, browser data, cookie data, username data, password data, and encryption data; and
said document code module further comprises at least one of a title, a label, a description, a shape, a line, a frame, a panel, a table, a dialog box, a drop-down menu, a list, a combo box, a text box, a radio selection button, an option button, a checkbox, a command button, a formatting tag, and option group, a toggle button, an unbound object frame, a bound object frame, a page break, a tab control, a sub-form, a sub-report, a style sheet, a static variable, a dynamic variable, a parametric variable, a spreadsheet, a web object, an OLE object, a plug-in, script code, sound, animation, and video.

20. A method for providing an e-commerce storefront, said method comprising the steps of:
providing a database having data stored therein;
providing at least one web code module comprising HTML markup language, said HTML markup language of said web code module at least partially derived from data in said database;
said web code module comprising at least one of a standard module with substantially predefined properties, a custom module with substantially user-defined properties, a sub-module, an invisible module, a dummy module, and a nested module; and
providing a web browser management interface for at least one of inserting, removing, hiding, showing, moving, modifying and administrating at least one web code module in order to produce at least a portion of said storefront web content.
